(19) United States
(12) Patent Application Publication
(10) Pub. No.: US 2024/0116549 A1
(43) Pub. Date: Apr. 11, 2024

(54) DEVICE FOR MOVING A LOAD ROLLING ON RAILS

(71) Applicant: GILLET GROUP, NOGENT (FR)

(72) Inventors: Fabrice PETIT, ORCEVAUX (FR); Antoine DETOURBET, Villiers les Aprey (FR)

(73) Assignee: GILLET GROUP, NOGENT (FR)

(21) Appl. No.: 18/546,154

(22) PCT Filed: Feb. 10, 2022
(86) PCT No.: PCT/EP2022/053281

§ 371 Date: Aug. 11, 2023

(30) Foreign Application Priority Data
Feb. 12, 2021 (FR) 2101370

(51) Int. Cl. B61J 3/12

(52) U.S. Cl. CPC B61J 3/12

(57) ABSTRACT

A movement device for moving a load provided with wheels and rolling on railway rails, including at least: a geared motor of which the shaft has a horizontal axis of rotation, a drive roller rotated by the shaft of the geared motor, and two support rollers rotated by adhesion by the drive roller. The movement device includes at least: an arm secured by one of its ends to the shaft of the geared motor and extending horizontally and perpendicularly to the axis of rotation, and a brake shoe secured to the free end of the arm and configured so as to be placed in the vicinity of the wheel of the load to be moved on the side opposite to the drive roller.

### TECHNICAL FIELD OF THE INVENTION

The present invention relates to the field of devices for moving heavy rolling loads, and more specifically devices for moving heavy loads rolling on railway rails.

### PRIOR ART

Most railway companies have rolling loads such as cars, trains of cars or locomotives that need to be moved, in particular in their workshops, in order to service, maintain and repair said rolling loads.

Movement devices are known to be used for this purpose, which movement devices comprise in particular a roller driven by a motor and engaged against the rolling surface of one of the wheels of said rolling loads so as to set the latter in motion.

In this respect, the international patent application WO 1984/002119 describes a drive device including a transportable carriage provided with two rolling cylinders and a drive cylinder actuated by a traction motor and disposed above said rolling cylinders such that, when the drive device is brought into contact with the wheel of a rolling load, frictional contact is established between the drive cylinder and the rolling cylinders, which causes the carriage to move on rotation of the drive cylinder and, at the same time, causes the rolling load to move by the rotation of its wheel driven by the rotation of the drive cylinder. The carriage further has a handle in which the cables, sheaths or similar elements for supplying power to the motor are preferably fitted, and which has control mechanisms such as switches or similar elements.

This type of drive device is effective, but has the major drawback of having to be fitted only at one of the ends of the rolling load to be moved, and so it cannot be fitted between the axles thereof. Moreover, this type of drive device requires the use of long power supply cables. Finally, with this type of drive device, once in motion, the rolling load will not stop in a given position, and will only stop when the kinetic energy thereof is zero.

Other types of drive device are described in the Japanese patent application JP 2014/080076 and the American patent application U.S. Pat. No. 4,125,029, however they also suffer from a number of drawbacks such as, for example, excessive weight or lack of autonomy, or are difficult to implement.

### SUMMARY OF THE INVENTION

The aim of the present invention is thus to overcome the aforementioned drawbacks and to offer an alternative to the known devices for driving a rolling load, this alternative being autonomous, compact, easy to move and to implement by a single operator, regardless of where it is implemented on said rolling load and allows said rolling load to be easily stopped in a given position.

The invention thus provides a device for moving a load provided with wheels and rolling on railway rails, the movement device comprising at least:
a geared motor whose shaft has a horizontal axis of rotation,
a drive roller attached to the free end of the shaft of the geared motor and rotated thereby, said drive roller being arranged to come to bear against one of the wheels of the load to be moved, and
two support rollers arranged to come to bear against the rail of the railway track receiving said wheel of the load to be moved and configured to be rotated by adhesion by said drive roller, said movement device being noteworthy in that it comprises at least:
an arm rigidly connected at one end thereof to the shaft of the geared motor and extending horizontally and perpendicularly to the axis of rotation of said shaft, and
a brake shoe rigidly connected to the free end of said arm and arranged, on the one hand, so as to be disposed in the vicinity of said wheel of the load to be moved on the side opposite to said drive roller and, on the other hand, so as to come to bear against said rail receiving said wheel.

It is clear that with this configuration, it is understood that the movement device according to the invention includes only one geared motor—drive and support rollers assembly, which makes the device more compact and less heavy while allowing the rolling load to be easily stopped in a given position.

Advantageously, the length of the arm can be adjusted.

Preferably, the arm is mounted such that it pivots on the shaft of the geared motor about the axis of rotation thereof, and the brake shoe is mounted such that it pivots at the end of the associated arm about an axis of rotation parallel to the axis of rotation of the shaft of the geared motor.

This particular configuration allows the brake shoe to be disposed on either side of the wheel of the rolling load in order to make the device for moving a load according to the invention easier to implement where necessary.

Advantageously, the arm includes a hinged joint disposed on the same side as the end rigidly connected to the shaft of the geared motor and allowing said arm to be moved from an “unfolded” position, wherein it is completely rectilinear, into a “folded” position.

The brake shoe is preferably a section of cylinder whose cross-section has the overall shape of an isosceles triangle, including a horizontal bottom face arranged to rest on the rail and two inclined faces arranged to receive the wheel of the load.

Advantageously, the brake shoe is made of elastomer.

According to an advantageous embodiment, the movement device includes a guide plate rigidly connected to at least the support rollers on the side opposite to the geared motor and extending beyond said support rollers, on the side opposite to the drive roller, and a guide plate rigidly connected to the brake shoe on the side opposite to the geared motor and extending beyond the bottom face of said brake shoe, on the side opposite to the inclined faces thereof.

The guide plate rigidly connected to the brake shoe is preferably associated with a retractable guide plate rigidly connected to the brake shoe on the geared motor side and may or may not extend beyond the bottom face of said brake shoe 9.

The movement device includes a carriage containing, at least in part, the geared motor, the drive roller, the two support rollers, the arm and the brake shoe, said geared motor being oriented so that the shaft thereof extends beyond the front face of the carriage, said carriage being provided, on the one hand, with at least a first retractable wheel allowing said movement device to be easily moved on a ground from the place of storage thereof to the place of use thereof and, on the other hand, at least a second wheel replacing the one or more first wheels to move said movement device when the latter is used to roll a load to be moved.

Each second wheel is advantageously height-adjustable and of the “jockey” wheel type.

Said movement device preferably includes:
a handlebar rigidly connected to the rear part of the carriage, adjustable in height and capable of being folded in order to remain ergonomic in all situations,
a control station, advantageously rigidly connected to said handlebar and provided with all elements required to control the movement device, and
an energy storage element of the rechargeable battery type to power the geared motor in particular.

### BRIEF DESCRIPTION OF THE FIGURES

Other advantages and features will be better understood upon reading the following description of one embodiment of the invention, given with reference to the accompanying figures, in which:

FIG. 1 is a front, perspective view of a drive device for driving a rolling load according to the invention,

FIG. 2 is a rear, perspective view of the drive device shown in FIG. 1,

FIG. 3 is a front, perspective view of the drive device according to the invention in the folded position,

FIG. 4 is a partial, side view of the drive device shown in FIG. 1, with its wheels in the lowered position,

FIG. 5 is a partial, side view of the drive device shown in FIG. 1, with its wheels in the raised position,

FIG. 6 is a partial view of the front face of the drive device shown in FIG. 1, implemented on a wheel of a rolling load,

FIG. 7 is an enlarged, close-up view of that shown in FIG. 6,

FIG. 8 is a side view of that shown in FIG. 7,

FIG. 9 is an enlarged, partial view of the drive device shown in FIG. 1.

### DESCRIPTION OF THE EMBODIMENTS

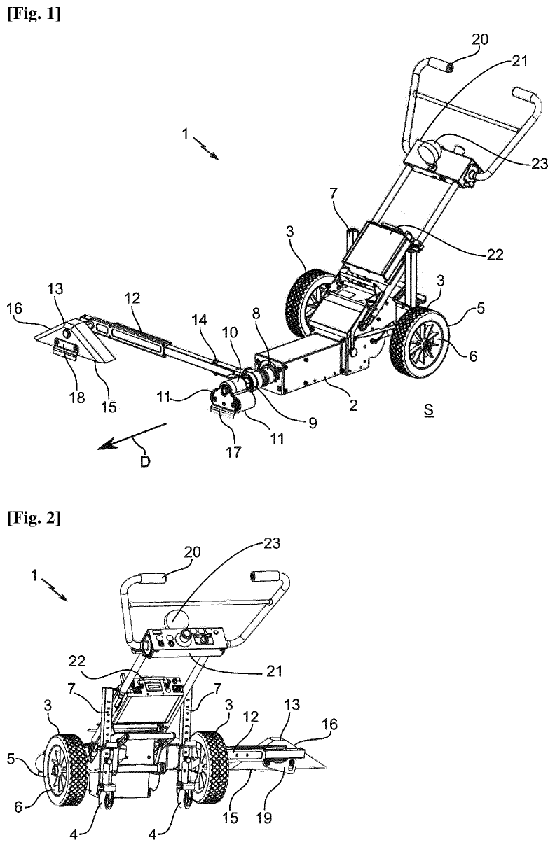

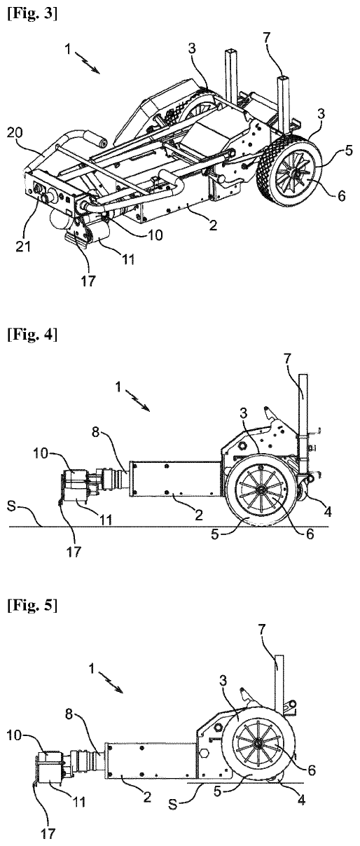

FIGS. 1 to 8 show a device 1 for moving a rolling load, not shown in the figures, such as, for example, cars, trains of cars or locomotives, and provided with wheels R configured to roll on railway rails V.

It goes without saying that the rails V in this case are assumed to be horizontal, however that they can also be inclined to a greater or lesser degree to the horizontal, in which case the terms horizontal, horizontally, vertical or vertically must be adapted.

With reference to FIGS. 1 to 5, the movement device 1 according to the invention comprises a carriage 2 provided, on the one hand, with at least one first wheel 3, advantageously two wheels for obvious stability reasons, allowing said movement device 1 to be moved easily on a ground S from the place of storage thereof to the place of use thereof and, on the other hand, at least one second wheel 4, advantageously two for obvious stability reasons, replacing the one or more first wheels 3 in order to move said movement device 1, when it is used to roll a load to be moved.

For ease of movement, each first wheel 3 preferably includes a tyre 5 mounted on a rim 6 and is mounted such that it pivots on the carriage 2 about a horizontal axis perpendicular to the sagittal plane (vertical plane, oriented from front to back) of said movement device 1.

The term “front” is used here to designate any element or part of an element of the movement device 1, according to the invention, that is located on the front side thereof along its normal direction D of movement, represented by the arrow in FIG. 1, and the term “rear” is used to designate any element or part of an element of said movement device 1 located on the opposite side.

Moreover, in order to allow it to be replaced by the one or more second wheels 4, each first wheel 3 can advantageously be retracted vertically between a “low” position wherein it bears against the ground S, the one or more second wheels 4 thus not being in contact with said ground S, and a “high” position wherein it is no longer in contact with the ground S, the one or more second wheels 4 thus bearing against said ground S so as to allow the movement device 1 to move when it is used to roll a load to be moved.

Furthermore, it is clearly understood that, in order to adapt the position of the movement device 1 to the dimensions of the load to be moved and/or of the rail V, the position of each second wheel 4 is advantageously adjustable in height. For this purpose, each second wheel 4 is rigidly connected to the carriage 2 by means of a vertical profile member 7, the length whereof can be adjusted. Moreover, to facilitate the movement of the movement device 1, each second wheel 4 is advantageously of the “jockey” wheel type and pivots about a horizontal axis, but can also pivot about a vertical axis.

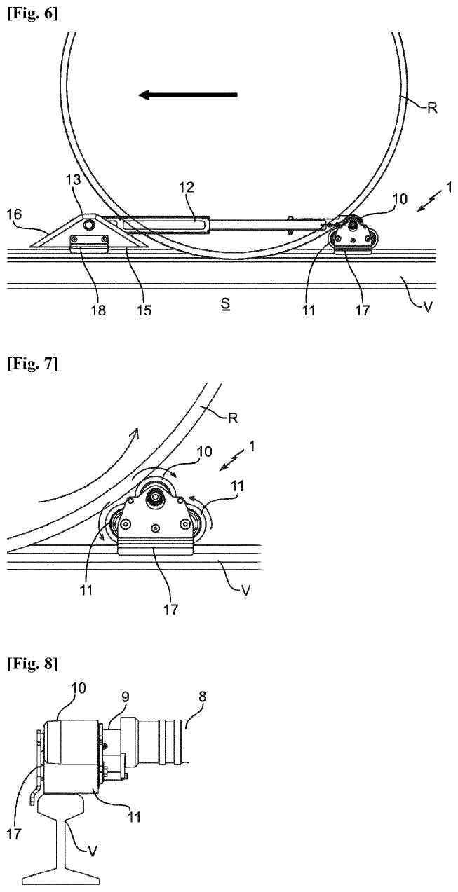

According to the embodiment shown in the figures, the movement device 1 includes at least the following elements contained at least in part in the carriage 2:
a geared motor 8 whose shaft 9 has a horizontal axis of rotation parallel to, and preferably lying within, the sagittal plane of the movement device 1, said geared motor 8 being oriented so that the shaft 9 thereof extends beyond the front face of the carriage 2,
a drive roller 10 attached to the free end of the shaft 9 of the geared motor 8 and thus rotated thereby, said drive roller 10 being arranged to come to bear against one of the wheels R of the load (Cf. FIG. 7) to be moved, and
two support rollers 11 arranged to come to bear against one of the rails V of the railway track receiving said wheel R of the load to be moved and configured to be rotated by adhesion by said drive roller 10.

For the last point, said support rollers 11 pivot about horizontal axes that are coplanar and parallel to the axis of rotation of the shaft 9 of the geared motor 8 and are disposed on either side of said drive roller 10 and lower than the latter such that, when said drive roller 10 rotates, it rotates the two support rollers 11 therewith by adhesion.

The movement device 1 further includes:
an arm 12 rigidly connected at one end thereof to the shaft 9 of the geared motor 8 and extending horizontally and perpendicularly to the axis of rotation of said shaft 9, and
a brake shoe 13 rigidly connected to the free end of said arm 12 and arranged, on the one hand, so as to be disposed in the vicinity of said wheel R of the load (Cf. FIG. 6) to be moved on the opposite side and, on the other hand, so as to come to bear against the rail V of the railway track receiving said wheel R.

It goes without saying that the movement device 1 can include a single support roller 11 while still remaining within the scope of the present invention. However, it is clearly understood that for obvious stability reasons, the movement device 1 will advantageously include two support rollers 11 disposed in the configuration described hereinabove.

To increase adhesion, the drive roller 10 and support rollers 11 are each covered with a polymer coating.

To enable the position of the brake shoe 13 to be adapted to the size of said wheel R of the load to be moved, the length of the arm 12 can advantageously be adjusted.

Furthermore, to enable the drive roller 10—support rollers 11 assembly of the movement device 1 to be fitted on either side of the wheel R of the load to be moved, the arm 12 is advantageously mounted such that it pivots on the shaft 9 of the geared motor 8 about the axis of rotation thereof in order to position the brake shoe 13 on either side of said drive roller 10—support rollers 11 assembly. According to this hypothesis, it is clearly understood that the brake shoe 13 will be mounted such that it pivots at the end of the associated arm 12 about an axis of rotation parallel to the axis of rotation of the shaft 9 of the geared motor 8 in order to correctly position the bearing face of the brake shoe 13 on the rail V of the railway track receiving said wheel R.

In order for the movement device 1 to be compact when not in use (Cf. FIG. 3), the arm 12 includes a hinged joint 14 disposed on the same side as the end rigidly connected to the shaft 9 of the geared motor 8 and allowing said arm 12 to be moved from an “unfolded” position wherein it is completely rectilinear into a “folded” position wherein the portion of the arm 12 extending from the hinged joint 14 to the brake shoe 13 pivots to form an angle of between 60° and 120°, advantageously equal to 90°, with the portion of the arm 12 extending from the hinged joint 14 to the shaft 9 of the geared motor 8.

According to one advantageous embodiment, the brake shoe 13 is a section of cylinder whose cross-section has the overall shape of an isosceles triangle, including a horizontal bottom face 15 arranged to rest on the rail V and two inclined faces 16 arranged to receive the wheel R of the load. The brake shoe 13 is made of elastomer in order to improve adhesion, in particular on said rail V.

Moreover, to make it easier to guide the movement device 1 along the rail V, the drive roller 10—support rollers 11 assembly and the brake shoe 13 each include at least one guide plate 17, 18 arranged to bear against the edge of said rail V. The guide plate 17 is rigidly connected to at least the support rollers 11 on the side opposite to the geared motor 8 and extends beyond said support rollers 11 on the side opposite to the drive roller 10. Similarly, the guide plate 18 is rigidly connected to the brake shoe 13 on the side opposite to the geared motor 8 and extends beyond the bottom face 15 of said brake shoe 13 on the side opposite to the inclined faces 16 thereof. The guide plate 18 is advantageously associated with a retractable guide plate 19 rigidly connected to the brake shoe 13 on the geared motor 8 side and may or may not extend beyond the bottom face 15 of said brake shoe 13.

To make it easier to use, the movement device 1 further includes a certain number of auxiliary devices. The movement device 1 thus includes:
a handlebar 20 rigidly connected to the rear part of the carriage 2, adjustable in height and capable of being folded in order to remain ergonomic in all situations,
a control station 21, advantageously rigidly connected to said handlebar 20 and provided with all the elements required to control the movement device 1, and in particular allowing the geared motor 8 to be started, the direction of rotation thereof to be selected and the rotation to be stopped in an emergency, and
an energy storage element 22 of the rechargeable battery type to power the geared motor 8 in particular.

The movement device 1 can further include a headlight 23 rigidly connected to the handlebar 20 and illuminating the area in which said movement device 1 is used.

With reference to FIGS. 6 to 8, with this configuration, in order to move a load with wheels R on rails V with the movement device 1 according to the invention, the steps as described below are carried out.

The movement device 1 is firstly moved using the handlebar 20 to position the drive roller 10—support rollers 11 assembly close to one of the wheels R by placing said two support rollers 11 on the rail V and the drive roller 10 in the vicinity of said wheel R. By adjusting the length and orientation of the arm 12, the brake shoe 13 is positioned close to the wheel R on the side opposite to said drive roller 10—support rollers 11 assembly such that the horizontal bottom face 15 of said brake shoe 13 is placed on the rail V and such that one of the inclined faces 16 thereof is in the vicinity of the wheel R.

The position of the second wheels 4 is adjusted using the vertical profile member 7, so that they bear against the ground S, then the first wheels 3 are raised into their “high” position.

The geared motor 8 is then started up using the control unit 21 in order to rotate the drive roller 10, which rotates the two support rollers 11 therewith by adhesion, causing the drive roller 10—support rollers 11 assembly as well as the arms 12 and the brake shoe 13 to move along the rail V. When said drive roller 10—support rollers 11 assembly arrives beneath the wheel R of the load to be moved, it is wedged between said wheel R and the rail V, and the drive roller 10 then transmits the driving torque to the wheel R by adhesion, thus causing the load rolling on the rail V to move, the latter moving as long as the geared motor 8 is in operation.

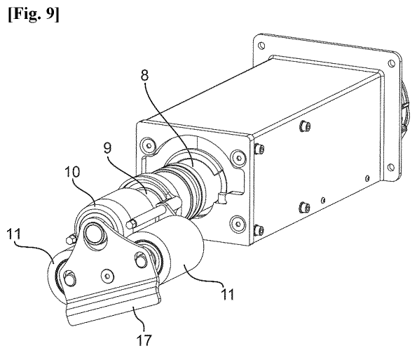

With reference to FIG. 9, in order to avoid any sudden movement when the drive roller 10—support rollers 11 assembly becomes wedged beneath the wheel R of the load to be moved, the drive roller 10—support rollers 11 assembly can advantageously pivot about the shaft 9 of the geared motor 8.

Finally, to stop the load at a desired place, the geared motor 8 is stopped, the drive roller 10—support rollers 11 assembly then stops on the rail V, while the load continues to advance by inertia, until the wheel R thereof comes against the brake shoe 13 and comes to a stop.

One particular application of the movement device 1 according to the invention is that of the movement of loads rolling on rails V of a railway track. However, it is clear that the movement device 1 can be adapted and used to move other types of loads such as, for example, rolls of paper or steel sheet.

Finally, it goes without saying that the examples of the movement device 1 according to the invention that have been described above are only specific illustrations and in no way limit the invention.

1-11. (canceled)

12. A movement device for moving a load provided with wheels and rolling on railway rails, the movement device comprising at least:
a geared motor whose shaft has a horizontal axis of rotation,
a drive roller attached to the free end of the shaft of the geared motor and rotated thereby, said drive roller being arranged to come to bear against one of the wheels of the load to be moved,
two support rollers arranged to come to bear against the rail of the railway track receiving said wheel of the load to be moved and configured to be rotated by adhesion by said drive roller,
an arm rigidly connected at one end thereof to the shaft of the geared motor and extending horizontally and perpendicularly to the axis of rotation of said shaft, and
a brake shoe rigidly connected to the free end of said arm and arranged, on the one hand, so as to be disposed in the vicinity of said wheel of the load to be moved on the side opposite to said drive roller and, on the other hand, so as to come to bear against said rail of the railway track receiving said wheel, wherein the arm is mounted such that it pivots on the shaft of the geared motor about the axis of rotation thereof, and the brake shoe is mounted such that it pivots at the end of the associated arm about an axis of rotation parallel to the axis of rotation of the shaft of the geared motor.

13. The movement device according to claim 12, wherein the length of the arm can be adjusted.

14. The movement device according to claim 12, wherein the arm includes a hinged joint disposed on the same side as the end rigidly connected to the shaft of the geared motor and allowing said arm to be moved from an unfolded position, wherein it is completely rectilinear, into a folded position.

15. The movement device according to any claim 12, wherein the brake shoe is a section of cylinder whose cross-section has the overall shape of an isosceles triangle, including a horizontal bottom face arranged to rest on the rail and two inclined faces arranged to receive the wheel of the load.

16. The movement device according to claim 12, wherein the brake shoe is made of elastomer.

17. The movement device according to claim 15, further comprising a guide plate rigidly connected to at least the support rollers on the side opposite to the geared motor and extending beyond said support rollers, on the side opposite to the drive roller, and a guide plate rigidly connected to the brake shoe on the side opposite to the geared motor and extending beyond the bottom face of said brake shoe, on the side opposite to the inclined faces thereof.

18. The movement device according to claim 17, wherein the guide plate rigidly connected to the brake shoe is associated with a retractable guide plate rigidly connected to the brake shoe on the geared motor side and may or may not extend beyond the bottom face of said brake shoe.

19. The movement device according to claim 12, further comprising a carriage containing, at least in part, the geared motor, the drive roller, the two support rollers, the arm and the brake shoe, said geared motor being oriented so that the shaft thereof extends beyond the front face of the carriage, said carriage being provided, on the one hand, with at least a first retractable wheel allowing said movement device to be easily moved on a ground from the place of storage thereof to the place of use thereof and, on the other hand, at least a second wheel replacing the one or more first wheels to move said movement device when the latter is used to roll a load to be moved.

20. The movement device according to claim 19, wherein each second wheel is height-adjustable and is of a jockey wheel type.

21. The movement device according to claim 19, further comprising:
a handlebar rigidly connected to the rear part of the carriage, adjustable in height and capable of being folded in order to remain ergonomic in all situations,
a control station, advantageously rigidly connected to said handlebar and provided with all elements required to control the movement device, and
an energy storage element of the rechargeable battery type to power the geared motor in particular.
